(19) United States
(12) Patent Application Publication
(10) Pub. No.: US 2005/0177518 A1
(43) Pub. Date: Aug. 11, 2005

(54) Electronic funds transfer and electronic bill receipt and payment system

(76) Inventor: Collie D. Brown, Mount Vermon, NY (US)

Correspondence Address: Collie D. Brown, 206 North Columbus Ave., Mount Vernon, NY, 10552, US

(21) Appl. No.: 10/775,903

(22) Filed: Feb. 10, 2004

(51) Int. Cl. H04L 9/00

(52) U.S. Cl. 705/64

(57) ABSTRACT

A software system that is used by consumers with electronic communications systems such as email or instant messaging, and an account such as a checking account to leverage these systems to transfer funds electronically to other consumers and businesses with similar electronic communications systems and to receive and pay bill electronically. Electronic funds transfers and bills are electronically signed (20A-D, 61) using the funds transfer creator's private electronic signature key. Keys are based on Public Key Infrastructure specification and include algorithms such as Diffie-Hellman or RSA Pat No 4,405,829. Bills and funds transfers are validated using its creator's public key.

### CROSS-REFERENCE TO RELATED APPLICATIONS

Not applicable.

### BACKGROUND—FIELD OF INVENTION

this invention relates to using email, instant messaging and other communication systems used by consumers to transfer funds electronically as well as to receive, and pay bills electronically.

### BACKGROUND OF THE INVENTION

Today people wanting to transfer funds to friends, pay bills, or transfer funds to friends or family in another location or country, have a few options available. These options include mailing checks or money orders, or using services such as Western Union or American Express Moneygram. These options are slow, expensive and or inconvenient. Utilizing a country's postal system to deliver checks or money orders requires the person or entity transferring the funds to purchase stamps, envelopes and in the case of money orders, a trip to the store that sells the money order to purchase it. This additional effort is expensive and time consuming; money transfer services require a trip to the money transfer office by the entity transferring the funds and by the entity receiving the funds. In addition, money transfer services are more expensive than the postal system.

Another way in which funds can be transferred requires the entity transferring the funds to provide its account information such as a bank account and routing number, to the entity receiving the funds. The entity receiving the funds, prints a check or draft with the information provided by the payer. The check or draft is then deposited using the same process as if a check was received from the payer. The one advantage this method offers is, it eliminates the need for the payer to purchase an envelope, the required postage stamp and the trip to deposit the envelope into the postal system. A major disadvantage of this method of funds transfer is the risk of the account information falling into the wrong hands and being used fraudulently. Another disadvantage of this funds transfer method is the additional expense required to purchase the appropriate paper draft or check writing software, hardware, and specialized paper required to print the draft or check. Finally, entities receiving this form of funds transfer incur additional expense to protect the information provided by the entity where the funds are coming from, this makes it less attractive to small companies and individuals.

Companies sending bills to customers and clients face similar problems in receiving payment. Most companies utilize their country's postal system to deliver bills to their customers and clients; delivering bills by this method has a long turn around time, usually more than a week. A company's funds are tied up while it waits for remittance payments to arrive. A few companies have implemented a partial solution to this long turnaround time; they send bills to their customers and clients as human readable text emails. In order to pay the bills, the email must be printed and a portion of the printed bill is removed and placed in an envelope along with a check or money order before being mailed back to the bill sender. This form of remittance follows the same procedure as traditional paper remittances; it utilizes a country's postal system, it also requires the payer to have a printer and printer paper. If the bill arrives and there is no printer or printer paper available, the bill cannot be paid by this method. Additionally, the payer must continue to purchase stamps, envelopes and make the trips to deposit the payment into the postal system.

This invention provides a totally electronic, convenient means of transferring funds, receiving and making payments using existing systems available to the typical computer user today. It allows funds to be transferred or bills to be paid by email or other communications means, including Instant Messaging, FTP, and HTTP. It leverages Public Key Infrastructure (PKI) specification based electronic signatures and certificates to provide identity verification and to detect if a transaction's data has been altered. Anyone using this invention to transfer funds or pay bills must have an account that allows funds to be transferred from it, such as a bank checking account. This requirement is easily met since most bill payers have such an account. The recipient of the funds must also have an account that accepts funds transfer from another FI.

This invention requires bill senders to obtain an electronic signing certificate from a recognized certification authority (CA) and to electronically sign all bills sent to anyone that will be paying the bill using this inventions electronic funds transfer process. The requirement for the bill sender receiving funds is the same as for the electronic funds transfer requirement described above. This invention uses payment information from the bill to pre-populate the remittance funds transfer, (check), the payer fills in any additional or missing information required for creating the electronic funds transfer.

### SUMMARY

It is an object of this invention to allow funds to be transferred or bills to be paid electronically by email, instant messaging, HTTP, FTP or other communications means.

### Objects and Advantages

Accordingly, beside the objects and advantages of the electronic funds transfer and bill payment process described above in the above patent application description, several objects and advantages are
a) to allow users of this invention to create and send electronic checks by email to anyone with an email address and an account capable of receiving funds transferred from other FI. Examples of such account include a bank checking or savings account;
b) to allow users of this invention to create and send electronic funds transfer to a recipient, by various electronic communications means, including Email, HTTP, FTP and Instant Messaging, that has an account capable of receiving funds transferred from other FI;
c) to allow bill senders to send electronic bills to bill payers with email accounts and receive payment using the method of this invention;
d) to allow bill senders to send electronic bills to bill payers with email accounts and receive payment using the method of this invention;
e) to allow bill senders to send electronic bills to bill payers by various communication means including, HTTP, FTP, Instant Messaging, and to receive payment using the method of this invention;
f) to combine the activity of reading electronic communications with receiving and paying bill electronically, for more efficient use of the bill payers time;
g) to decrease the turnaround time for bill remittance;
h) to use the habit of bill payers reading their electronic messages to remind them of unpaid bill by including such reminders with these messages;

Further objects and advantages will become apparent from a consideration of the ensuing descriptions and drawings.

### DRAWINGS FIGURES

In the drawings, closely related figures have the same number but different alphabetic suffixes. Elements in each figure that are closely related also have the same number but different alphabetic suffixes.

FIG. 1 shows a prospective user of the electronic funds transfer, bill receipt and remittance process of this invention being authenticated.

FIG. 2A shows an electronic check created with the electronic funds transfer process of this invention being sent by email to a recipient. The recipient's email software implements this invention thereby allowing the recipient to process the electronic check without additional software.

FIG. 2B shows an electronic check created with the electronic funds transfer process of this invention being sent by email to a recipient. The recipient download and installs separate software with this invention capability, to process the electronic check.

FIG. 2C shows electronic funds transfer transaction being sent by one of the many electronic communications transport protocol available to the funds recipient. The recipient's communication software implements the capabilities of this invention thereby allowing the recipient to process the electronic funds transfer without additional software.

FIG. 2D shows electronic funds transfer transaction being sent by one of the many electronic communications transport protocol available to the funds recipient. The recipient download and installs separate software with this invention capability, to process the electronic funds transfer.

FIG. 3A shows an electronic bill with its electronic signature being sent to the payer's email account. The recipient's email software implements this invention thereby allowing the recipient to open, verify and pay the bill using an electronic check created from the funds transfer method of this invention.

FIG. 3B shows an electronic bill with its electronic signature being sent to the payer using one of the many electronic communications transport protocols available. The recipient's communication software implements this invention thereby allowing the recipient to open, verify and pay the bill using the electronic funds transfer method of this invention.

FIG. 3C shows an electronic bill with its electronic signature being sent to the payer using one of the many electronic communications transport protocols available. The recipient download and installs separate software with this invention's capability, open, verify and pay the bill using the electronic funds transfer method of this invention.

FIG. 4 shows an alternate method of processing the funds transfer by starting with the funds recipient sending the funds transfer data to their FI instead of the funds transfer creator's FI.

### REFERENCE NUMERALS IN DRAWINGS

10 software used by customers of FI to create, transmit, receive and process electronic funds transfers, using PKI based electronic signature keys to sign and validate funds transfer data. The software also receives and processes electronic bills
11 authentication information including names, social security and account numbers, being sent to a FI by one of its customers so that the FI can validate the customer's identity
12 the customer's identity verification is done by their FI
13 the FI's customer identity has been confirmed, an electronic signature signing certificate along with account reference numbers or encrypted account numbers to be used when funds are being transferred along with other relevant information is returned to the customer
14 the FI could not verify the identity of the customer so a rejection notice is sent back to the customer
20A an electronic funds transfer transaction being used as an electronic check accompanied by its electronic signature being sent as an email file attachment
20B an electronic funds transfer transaction accompanied by its electronic signature being sent using one of the many Internet transport means available, to the recipient of the funds
21A Email software used by the electronic check recipient receives the check as an email file attachment. The email software has the electronic funds transfer, bill receipt and remittance capabilities of this invention embedded or integrated
21B Email software used by the electronic check recipient receives the check as an email file attachment. The email software does not have the electronic funds transfer, bill receipt and remittance capabilities of this invention embedded or integrated
21C software capable of receiving the electronic funds transfer, bill data by one of the many Internet transport means such as EMAIL, FTP, HTTP, or INSTANT MESSAGING. The software has the electronic funds transfer, bill receipt and remittance capabilities of this invention embedded or integrated
21D software capable of receiving the electronic funds transfer, bill data by one of the many Internet transport means such as EMAIL, FTP, HTTP, or INSTANT MESSAGING. The software does not have the electronic funds transfer, bill receipt and remittance capabilities of this invention embedded or integrated.
22 the recipient checks to see if software with the electronic funds transfer, bill receipt and remittance capabilities of this invention is installed
23 the software is not installed so it is downloaded and installed
25 the electronic signature and data of the funds transfer, bill received is verified
26 the electronic signature or data validation fails, the sender is notified
27A the check recipient transmits the electronic check along with their account information where the funds will be deposited, by HTTP to the check writers FI to be deposited.
27B the funds recipient transmits the electronic funds transfer data along with their account information where the funds will be deposited, using one of the many Internet transport protocols available, to the funds creator's FI where the funds transfer occurs
27C the funds transfer recipient transmits the electronic funds transfer data along with the account information where the funds will be deposited, using one of the many Internet transport protocols available, to their FI
40 the check writer's financial institution
40B Funds transfer creator's financial institution
50 the funds recipient's financial institution
60 a company or entity that sends electronic bills
61 an electronic bill that has been signed using PKI based electronic signature key and includes the certificate provided by the entity that verified the identity of the billing company. The electronic bill is formatted such that software implementing the funds transfer process of this invention is able to open and extract the payment data to be used in creating the electronic funds transfer remittance for the bill

### DRAWING DESCRIPTIONS

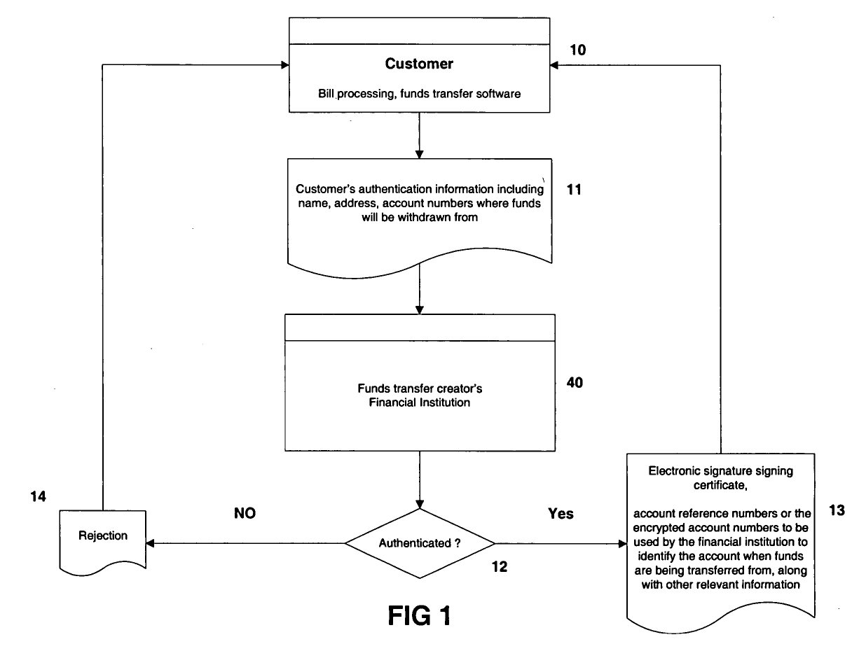

### FIG. 1

shows a FI validating the identity of one of its customers. The customer is provided with software 10 that is used to create and process electronic funds transfers, and open and pay electronic bills. The customer uses the software 10 to send information to the FI 40 where the identity of the customer is confirmed. Positive identity confirmation results in the FI sending an electronic signing certificate, along with any additional information needed by the customer to initiate a funds transfer, to the customer.

### FIG. A—Funds Transfer using Electronic Check—Preferred Embodiment

Shows the FI's customer creating an electronic check using the funds transfer process of this invention; an electronic check is created 20A and sent by email to the email address of the check recipient (depositor). The electronic check is signed using the electronic signature keys of the check creator FIG. 1. The recipients email software 21A implements this invention thereby allowing the check recipient to open and validate the check 25. If the check and its electronic signature are valid, the recipient adds the information for account where the check will be deposited 27A, before sending the combined check data and depositor's account information to the check writers FI 40. The check writer's FI transfers the funds from the check writer's account to the depositor's FI where the funds are placed into the depositor's account.

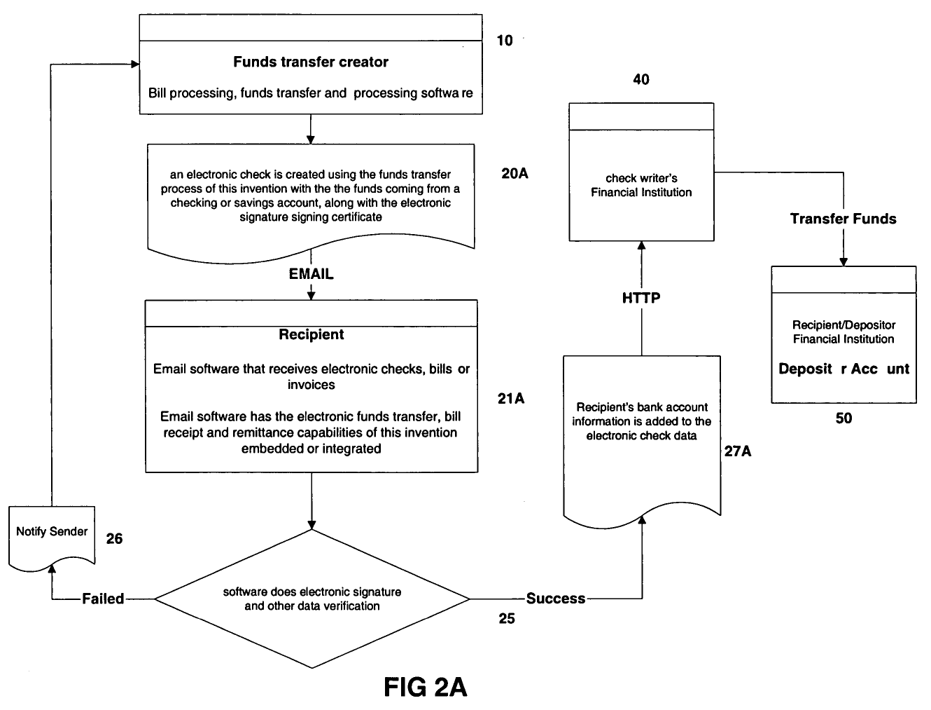

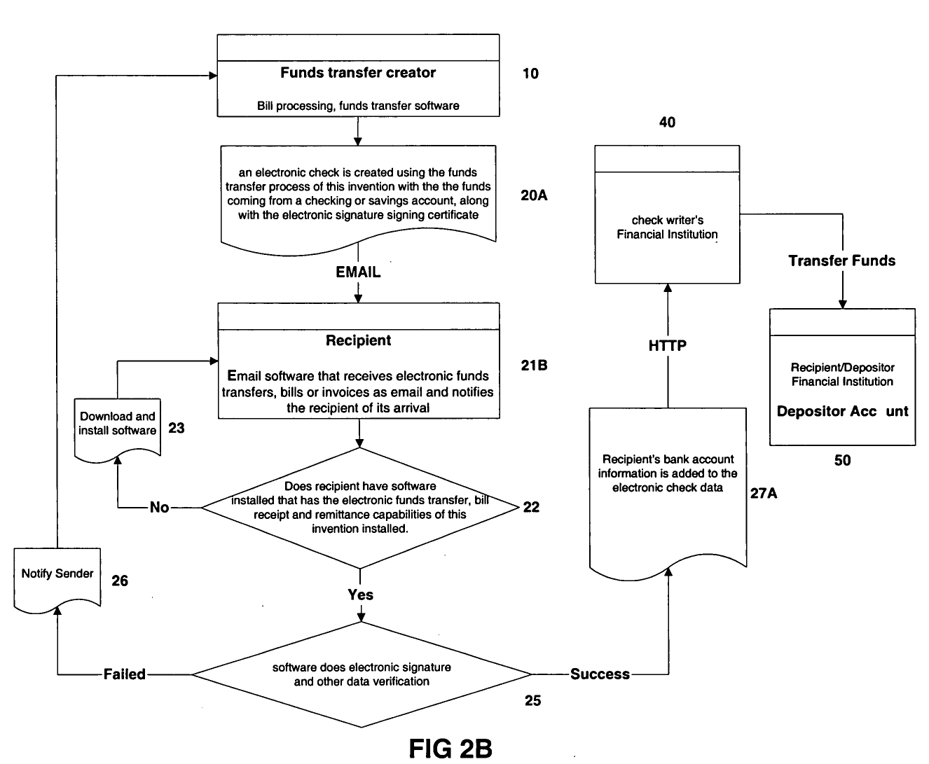

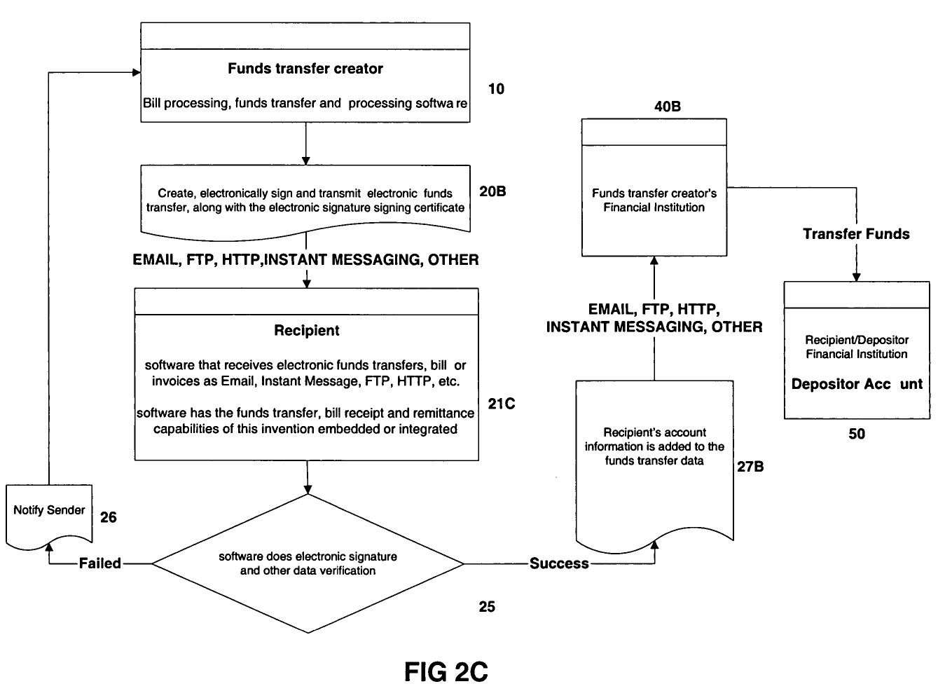

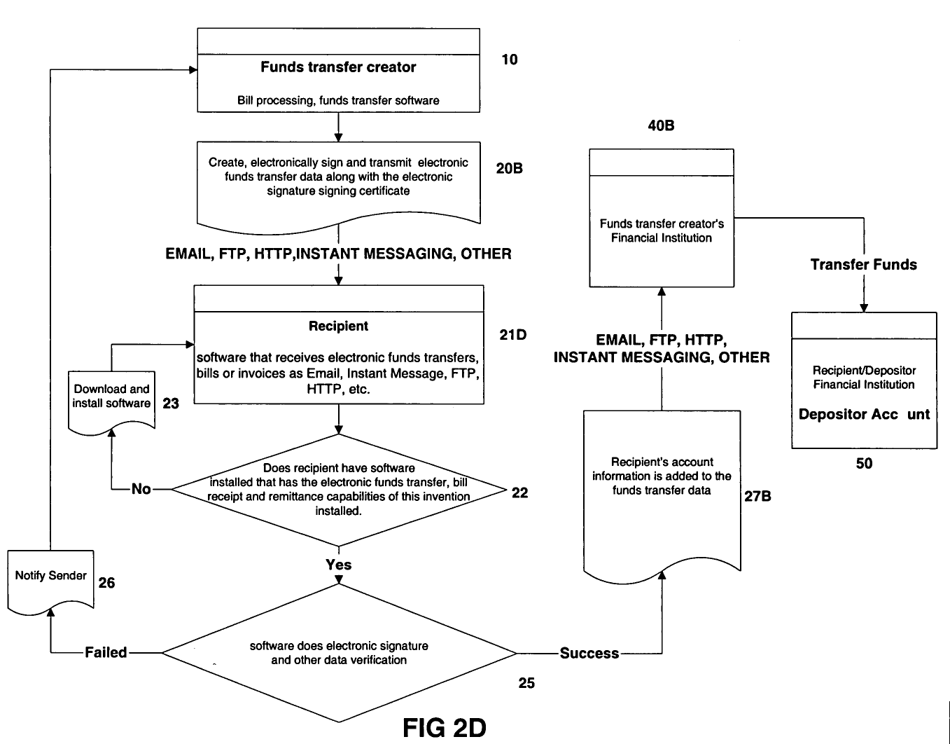

### FIG. 2B—Funds Transfer using Electronic Check—Alternate Embodiment

Shows the FI's customer creating an electronic check using the funds transfer process of this invention; an electronic check is created 20A and sent by email to the email address of the check recipient (depositor). The electronic check is signed using the electronic signature keys of the check creator FIG. 1. The recipients email software 21B does not have the functionality of this invention integrated or embedded, therefore the recipient of the electronic check must download and install separate software with this capability 23. The downloaded software is used to open and validate the check 25. If the check and its electronic signature are valid, the recipient adds the information for account where the check will be deposited 27A, before sending the combined check data and depositor's account information to the check writers FI 40. The check writer's FI transfers the funds from the check writer's account to the depositor's account or FI 50.

### FIG. 2C—Electronic Funds Transfer—Alternate Embodiment

Shows the FI's customer creating an electronic funds transfer transaction; an electronic funds transfer file is created 20B and sent by one of the many electronic communications transport protocol available to the funds recipient. The type of communications protocol used is determined by the type of electronic address the recipient has. The recipient's communication software implements the capabilities of this invention thereby allowing the recipient to open and process the funds transfer transaction data 21C. If the funds transfer data and its electronic signature are valid, the recipient adds the information for account where the funds will be deposited 27B, before sending the combined funds data and depositor's account information to the funds transfer creator's FI 40B. The funds transfer creator's FI transfers the funds to the recipient's account or FI 50.

### FIG. 2D−Electronic Funds Transfer—Alternate Embodiment

Shows the FI's customer creating an electronic funds transfer transaction; an electronic funds transfer file is created 20B and sent by one of the many electronic communications transport protocol available to the funds recipient. The type of communications protocol used is determined by the type of electronic address the recipient has. The recipient's email software 21D does not have the functionality of this invention integrated or embedded, therefore the recipient of the funds transfer data must download and install separate software with this capability 23. The downloaded software is used to open and validate the funds transfer data 25. If the funds transfer data and its electronic signature are valid, the recipient adds the information for account where the funds will be deposited 27B, before sending the combined funds data and depositor's account information to the funds transfer creator's FI 40B. The funds transfer creator's FI transfers the funds to the recipient's account or FI 50.

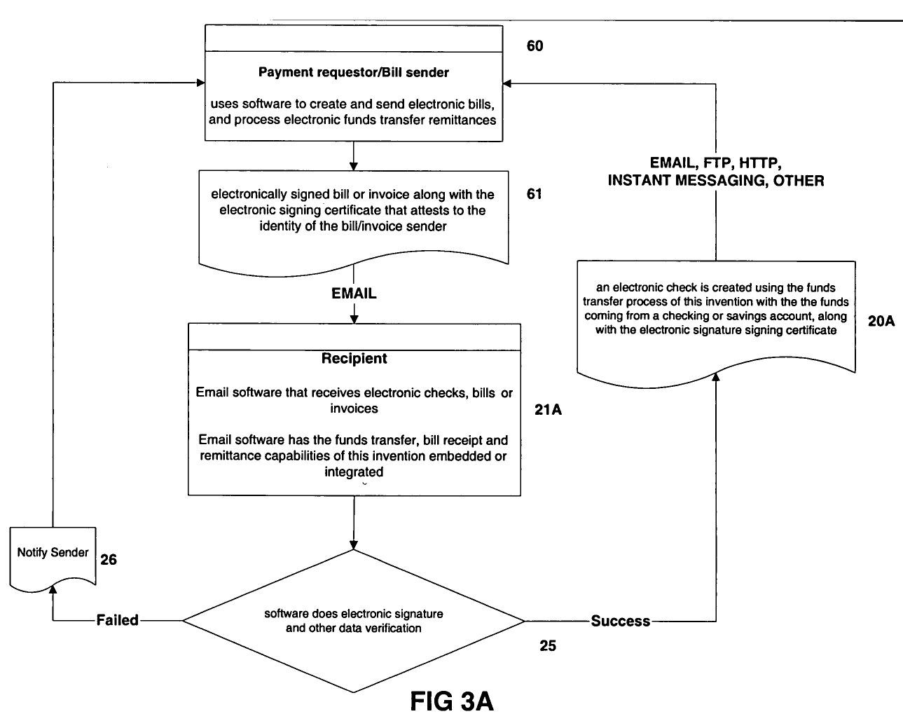

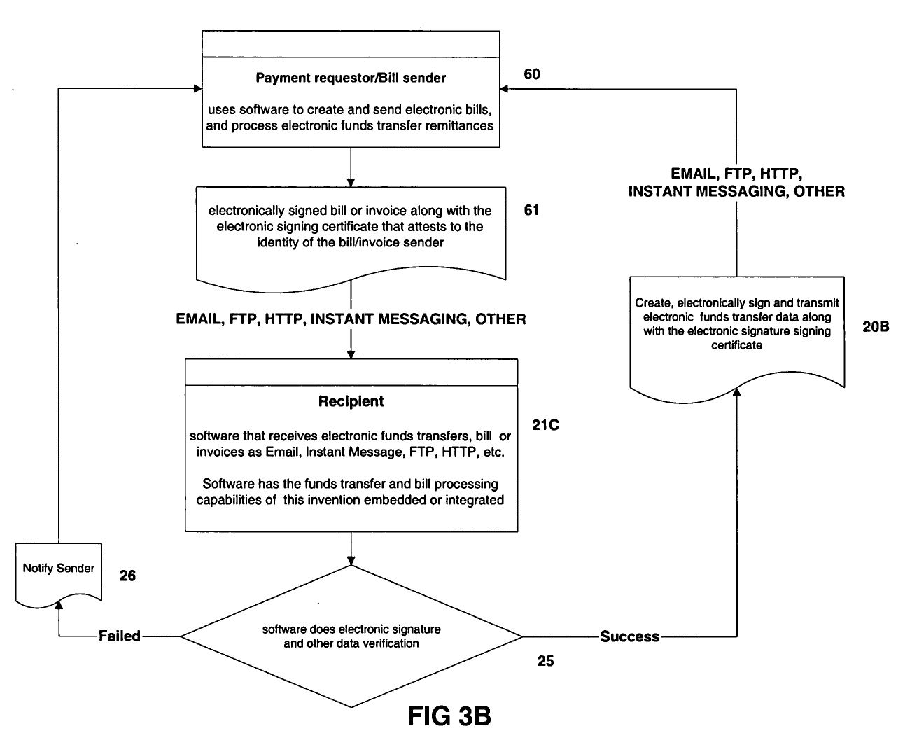

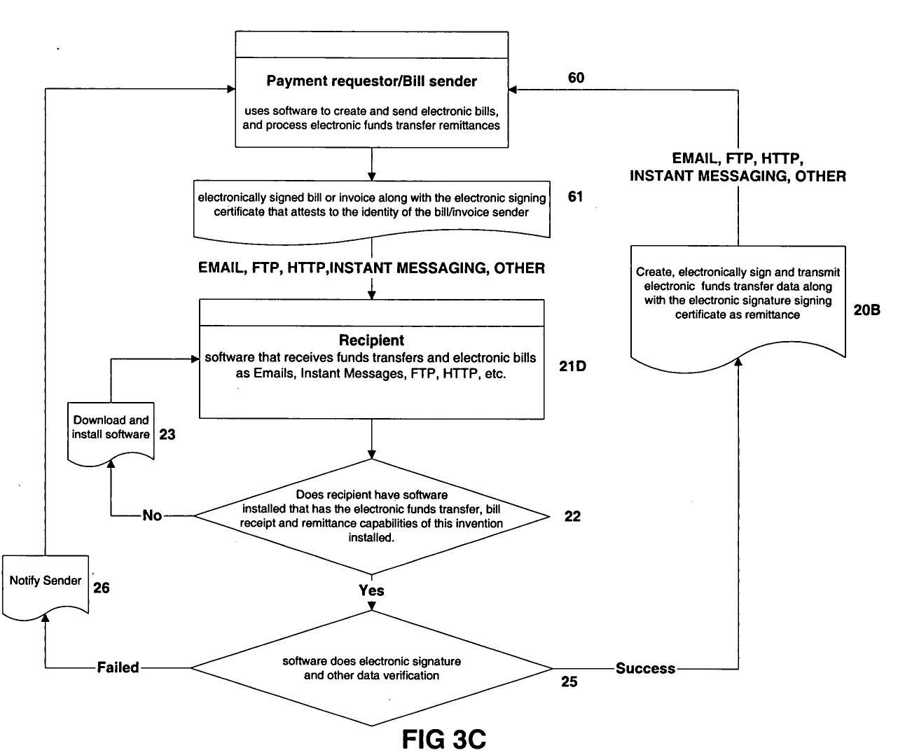

### FIG. 3A—Electronic Bill Receipt and Payment—Preferred Embodiment

shows an electronic bill, signed with the sender's private electronic signature key and includes the sender's electronic signing certificate, being sent by email to the bill payer's email account. The signing certificate, created by the certification authority (CA) which attests to the identity of the bill sender, is needed along with the electronic signature, by the recipient to determine the identity of the bill sender and to determine if the bill was altered. The recipient's email software implements this invention thereby allowing the recipient to open and pay the bill using an electronic check created by using the funds transfer method of this invention. Most or all of the data needed to fill in the check to be sent to the check recipient is extracted from the bill; this allows the payer to pay the bill with minimal effort. The electronic check (remittance) is sent to the bill sender and using the process defined in FIG. 2C, the check is processed by the bill sender.

### FIG. 3B—Electronic Bill Receipt and Payment—Preferred Embodiment

shows an electronic bill, signed with the sender's private electronic signature key and includes the sender's electronic signing certificate, being sent by one of the many electronic communications transport protocol available to the funds recipient. The type of communications protocol used is determined by the type of electronic address the recipient has. The signing certificate, created by certification authorities, (CA) which attests to the identity of the bill sender is needed along with the electronic signature, by the recipient to determine the identity of the bill sender and to determine if the bill was altered. The bill recipient's communications software implements this invention thereby allowing the recipient to open and pay the bill using the funds transfer method of this invention. Most or all of the data needed to fill in the funds transfer transaction is extracted from the bill; this allows the payer to pay the bill with minimal effort. The electronic funds transfer (remittance) is sent to the bill sender where the payment is processed using one of the processes defined in FIG. 2A-D.

### FIG. 3C—Electronic Bill Receipt and Payment—Preferred Embodiment

shows an electronic bill, signed with the sender's private electronic signature key and includes the sender's electronic signing certificate, being sent by one of the many electronic communications transport protocol available to the funds recipient. The type of communications protocol used is determined by the type of electronic address the recipient has. The signing certificate, created by certification authorities, (CA) which attests to the identity of the bill sender is needed along with the electronic signature, by the recipient to determine the identity of the bill sender and to determine if the bill was altered. The bill recipient's communications software does not have the functionality of this invention integrated or embedded, therefore the bill recipient must download and install separate software with this capability 23. The downloaded software is used to open and validate the bill 25. If the bill is validated, most or all of the data needed to fill in the funds transfer transaction is extracted from the bill to create the funds transfer remittance; this allows the payer to pay the bill with minimal effort. The electronic funds transfer (remittance) is sent to the bill sender where the payment is processed using one of the processes defined in FIG. 2A-D.

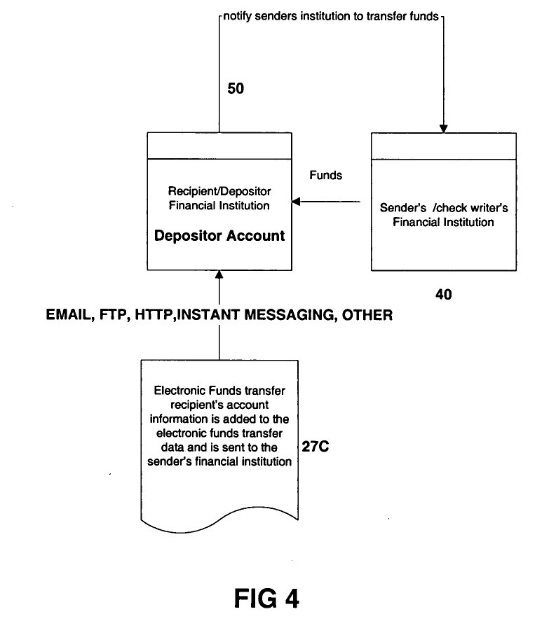

### FIG. 4—Transferring Funds at FI—Alternative Embodiment

shows an alternate method of processing the funds transfer by starting with the funds recipient sending the funds transfer data to their FI instead of the funds transfer creator's FI.

### Advantages

From the description above, a number of advantages of the electronic funds transfer and bill processing system become evident:
(a) leveraging bill payers electronic communications systems, bill senders lower the cost of sending bill and processing remitances by sending electronic the bills and receiving payments electronically whithout having to spend additional monies for pastage, and payer.
(b) utilizing this invention's funds transfer method private citizens can electronically transfer funds to one another without having to purchase expensive communications systems or services;
(c) Bill senders will experience faster turnaround time in sending bill and receiving payments beause the time used to transport bills using the postal system has been removed.
(d) Bill payment is easier and more convenient for bill payer because most of the payment data required to create the funds transfer transaction (remittance) is extracted from the bill, thereby reducing the number of data elements the payer needs to enter.
(e) By utilizing integrating a payers communication system which is used on a regular basis, with the bill receit and payment system of this invention, the likelyhood of the bill payer forgetting to pay a bill is reduced because the bill payer will likey come across a bill while dealing with other communucation.

### Operation—FIGS. 1,2,2b,3 and 4

This first paragraph describes the electronic signatures this invention uses; subsequent paragraphs explain the operations of the invention.

This invention utilizes electronic signature keys to sign electronic funds transfers and electronic bills, determine the identity of the signature creator, and determine if the signed data has been altered. Public Key Infrastructure (PKI) implementations require a pair of public private electronic signature keys to be generated. The private key is used to sign data (create electronic signature) and the public key is used to determine if the signed data has been altered. Because the keys are mathematically linked, a public key can only be used to validate signatures created by its associated private key. The keys are assigned to an entity; the private key is never revealed to anyone but that entity. A certification authority (CA) is an entity that attests to the ownership of a public key and by association, its private key. The public key is included in the certificate, which is then included in the electronic signature. The words, digital signature may be interchanged with the words electronic signature in this invention.

Before the electronic funds transfer and bill-processing software of this invention can be utilized, a number of conditions must exist. The conditions are, first, anyone wishing to use this invention must have access to software that implements this invention. Second, in order to send or receive funds transfers, receive or pay bills, one must have a means to communicate electronically including by email, instant messaging, HTTP, FTP. Third, in order to transfer or receive funds, one must have at least one account at a financial institution that may be used in funds transfers including checking or savings account. Fourth, the financial institution where the funds will be transferred from must agree to transfer the funds upon receipt of a valid electronically signed funds transfer request from the account holder. Fifth, the financial institution where the funds will be transferred to must agree to receive the funds from the FI where the funds are located.

Now that the environment is set, the first order of business is to enable the user of this invention 10 to create electronic funds transfers, to do this a user must be authenticated by their financial institution 40. Using software that implements this invention 10, the user transmit personal information including the user's name, address, social security number, numbers of the accounts to be used in funds transfers, along with any additional information 11 the financial institution 40 requires in order to validate the identity of the user.

A pair of electronic signature keys that are used to sign and validate electronic funds transfers are generated, if the user generates the keys, the public key must be transmitted along with the other verification information 11 to the FI 40. If the FI is unable to verify the identity of the user, the user is informed that they will not be able to create funds transfers or pay electronic bills 14. Upon successful identity verification, the FI, acting as a CA creates an electronic signature-signing certificate, 13 which is returned along with other information needed to create electronic funds transfers including reference numbers that are used by the FI to determine what account to transfer the funds from.

Using FIG. 2A-D as reference, to create an electronic funds transfer, the following data is required:
the number or ID of the account the funds will be transferred from
the amount of funds (money) to be tarnsfered
the electronic address of the recipient which may include but not limited to email, Instant Messaging, FTP, HTTP addressses
The electronic address of the funds transfer creator's FI where the funds transfer is sent by the recipient (depositor) to be processed
the electronic signing certificate 13 returned by the FI

Other information may be added where appropriate including:
a check number if the funds transfer is from a checking account
a bill number if the funds transfer is being used as payment for a bill the name of the user
the name and address of the funds transfer creator's FI
the current date (transaction date)
the name of the entity receiving the funds

To create the electronic funds transfer transaction, the creator uses its private electronic signature key to sign the funds transfer data 20A-B and transmits the signed data to the recipient. Data is transmitted to the recipient by Email, Instant Messaging, HTTP, FTP or some other type of electronic communication, the type used is determined by examining the electronic address of the recipient. A simple and easy way to transmit the funds transfer data is by Email or Instant messaging 21A-B, both of these forms of electronic communication is very common today and is more likely to be available to the sender and receiver. To enable funds transfer recipients, especially email and Instant Messaging users who may not have software that implements this invention installed or available, a software download link is included with the funds transfer transaction sent to recipeints.

Using their electronic communication software including email, Instant Messaging or web server, the recipient retrieves the funds transfer transaction data 21A-D. If the electronic communications software used by the recipient does not have the funds transfer methods of this invention integrated or embedded 21B,D or have software with this functionality installed 21A,C, the recipient uses the download link included with the funds transfer transaction to download and installs the software 23. To process the funds transfer transaction, the recipient loads the funds transfer data and validate its content including the electronic signature. If the signature or content has been altered or has missing information, the recipient will not be allowed to continue. If the content and signature are okay, the recipient (depositor) adds their deposit information to the transaction and the combined data is transmitted to the funds transfer creator's FI 40,B using the electronic address of the funds transfer creator's FI 40,B included in the funds transfer transaction data; this may include the name of the depositor's FI, the account number and routing number if the account receiving the funds is a bank checking account.

Upon receipt of the funds transfer transaction data and the depositor's information, the FI 40B validates the transaction data and its electronic signature. If the signature or data fails validation or there is insufficient funds to cover the transaction, the FI rejects the transaction, notifies the funds transfer creator and optionally, the depositor. The FI transfers funds to the account of the depositor if the FI of both parties is the same or to the depositors FI 50 along with the depositor's information where the account is located and the funds deposited.

### Paying Electronic Bills.

Using FIG. 3A-C as reference, before a bill sender can send electronic bills to be paid using the electronic funds transfer process of this invention, the bill sender must obtain an electronic signing certificate from a recognized certification authority (CA). To create the electronic bill you sign the bill data with the bill sender's private electronic signature key, combine the signed data with the electronic signature, and the electronic signing certificate 61. The electronic bill must include the electronic communications address of the bill sender where the funds transfer remittance is to be sent.

To allow the bill payer's funds transfer software to create and automatically populate the payment electronic funds transfer transaction, the following data elements should be included in the bill:
The name of the bill payer
The bill payer's account number
The date the bill is due
The date the bill was created
The amount (value) of the bill
The type of currency the bill is drawn on
The address of the bill payer if applicable
Bill or invoice number

The bill or invoice number if available, is included in the electronic funds transfer transaction and can be used by the bill sender to determine the account to credit the payment.

Data is transmitted to the bill payer by Email, Instant Messaging, HTTP, FTP or some other type of electronic communication, the type used is determined by examining the electronic address of the bill payer. A simple and easy way to transmit the electronic bill is by Email or Instant messaging 21A, both of these forms of electronic communication is very common today and is more likely to be available to the bill sender and payer. To enable bill payers, especially email and Instant Messaging users who may not have software that implements this invention installed or available, a software download link is included with the electronic bill sent to recipients.

Using appropriate Email, Web Server or Instant Messaging software, the bill payer receives the electronic bill 21A,C,D. To pay the bill using electronic funds transfer process, the recipient must have the electronic funds transfer software installed on their computer. If the software is not installed, the bill payer, using the link that is included with the bill, download and installs the software 23. The bill payer uses the software to open the bill 25. The software validates the bill's data and electronic signature and will not allow the bill payer to pay the bill if it's electronic signature is invalid or the bill has been altered.

A funds transfer remittance transaction is created and prepopulated with as much payment information that can be extracted from the bill; this reduces the amount of information the bill payer must put in manually. The electronic funds transfer remittance transaction is transmitted to the recipient using the addreess of the recipient that was included in the bill. The bill sender processes the payment using the process described for the funds transfer recipient described in FIG. 2A-D.

### CONCLUSION, RAMIFICATIONS AND SCOPE

Accordingly, the reader will see that our electronic funds transfer and bill payment system is more cost effective to use than traditional paper billing and funds transfer methods. It has additional advantages in that
By leveraging their existing means of electronic communication, including email and instant messaging, and an account such as checking or saving account that facilitates funds transfers, consumers can easily transfer funds to other consumers and business with similar electronic communications and an account where the funds can be deposited;
By using their electronic communications systems to facilitate funds transfers, consumers do not have to spend additional money to purchase postage, envelopes, make the trip to post office or mail box or spend the additional expense to transfer funds using money transfer services such as Western Union or American Express MoneyGram;
By using this invention to send bills and receive remittances electronically, companies save the cost of postage and envelopes, which can be considerable for large companies;
By utilizing this invention to send bills and receive payments electronically, bill senders experience faster turn around times for bill payments;
Bill payers using this invention to pay bills expreience monetary savings by not having to purchase stamps, envelopes, or make trips to the mail box or post office to mail bills.

1) a method for electronically transferring funds from the account of a financial institution's customer to the account of the recipient located at said FI or at another FI comprising:
(a) providing software capable of generating a pair of public-private electronic signature keys based on the Public Key Infrastructure (PKI) specification,
1. implemented using various encryption algorithms including RSA public key encryption from RSA Security Inc or any other suitable public private key encryption algorithms,
2. a means where keys may be generated by said FI or said customer, and if said keys are generated by said customer, the public key is provided to said FI where it is included in an electronic signing certificate that is created by said FI or its agents, for said customer,
(b) providing a means where said customer is given authorization to create electronic funds transfers after said customer's identity and account information are verified by:
1. requiring said customer to communicate to said FI, personal identifying information, information about the account to be used when creating funds transfer transactions, the public key to be used to verify funds transfer transactions created by said customer, if said public-private key was not generated by said FI, and any other information that is needed by said FI,
2. said FI or an agent acting on its behalf, acting as a certification authority, verifies the identity of said customer and the right to use the accounts specified, creates an electronic signing certificate by certifying the identity and ownership of said public key, specifying any terms and conditions regarding the use of said public key and its associated private keys,
3. authorize said customer to create electronic funds transfers by providing said customer with the following, said electronic signing certificate, private electronic signature keys if the keys are generated by said FI or one of its agent, account reference numbers or IDs that are used to identify the accounts where the funds will be transferred from,
(c) providing various software means wherein said customer creates an electronic funds transfer transaction by:
1. using said customers' private electronic signature key to sign (encrypt ) the hash of data including the account or account reference ID, the value of the funds to be transferred and any additional data needed to identify the transaction, specify uses or purposes, or the encrypting the data directly, and combining the signed data, the signature value which is the output of signing the data, and said signing certificate into an electronic funds transfer transaction data stream,
2. combining the signature value and the signing certificate and signing data to create an electronic signature,
(d) providing various means wherein said electronic funds transfer transaction data stream is transmitted electronically to the entity receiving the funds by various communication means including EMAIL, HTTP, FTP, INSTANT MESSAGING (IM),
(e) providing a means wherein the entity receiving said funds transfer transaction data stream, using software means, loads and validates said transaction data, and fails said validation if any of the following conditions exist, the transaction data is not what was expected, the electronic signature is invalid or its signing certificate has expired,
(f) Providing a means wherein the recipient of said funds transfer transaction data stream, after successfully validating the transaction data, adds the account information where the funds will be deposited, to the transaction data stream it received,
(g) Providing a means wherein the validated funds transfer transaction data stream and the account information added by said recipient, is transmitted to the funds transfer transaction creator's FI,
(h) Providing a means wherein the funds transfer transaction creator's FI, upon receipt of the funds transfer transaction data stream along with the funds recipient account information, perform similar validation as the funds recipient and any other validation it deems necessary before said FI transfers the funds from the funds transfer transaction creator's account to the account of the funds recipient or to the funds recipient's FI using existing FI to FI funds transfer means.
whereby consumers and other entities using this invention, leverages their existing means of electronic communication, including email and instant messaging, and an account including checking or saving account, at a FI that facilitates funds transfers, to transfer funds in the form of an electronic check to other consumers and businesses that also leverage their existing electronic communications means, this invention and accounts at their FI to process and deposit funds from said electronic check or funds transfer transaction into the recipient's account,
whereby consumers and other users of this invention receive tangible savings of time and money when they transfer funds to other consumers, businesses, and family members, including children in college, by not having to purchase postage stamps, envelopes, money orders or write paper check, making the trip to deliver the envelope to the post office or utilizing expensive money transfer services including Western Union or American express's MoneyGram,
whereby the recipient of the funds from the electronic check of this invention, further saves time by not having to visit the office or location of it's FI to deposit the electronic funds transfer or electronic check,
Whereby consumers and businesses can receive the benefits of transmitting funds electronically without spending valuable resources to purchase expensive communications systems, even when the funds being transferred are small.

2) The electronic funds transfer method of claim 1 further including transferring funds as electronic check comprising:
a. Providing a means wherein the type of account receiving the funds being transferred from include checking, saving account, money market, or brokerage account,
b. the type of account receiving the funds include checking, savings account, money market, or brokerage account,
c. providing a means to add additional data elements to said transaction data stream thereby allowing said data stream to be used an electronic check,
d. provide a means wherein said electronic check is transmitted to the check recipient by email, instant messaging or any suitable and available electronic communication means,
whereby consumers and other entities using this invention, leverages their existing means of electronic communication, including email and instant messaging, and accounts including checking or savings account, at a FI that facilitates funds transfers, to transfer funds in the form of an electronic check to other consumers and businesses that also leverage their existing electronic communications means, this invention and accounts at their FI to process and deposit funds from said electronic check or funds transfer transaction into the recipient's account,
whereby consumers and other users of this invention receive tangible savings of time and money when they transfer funds to other consumers, businesses, and family members, including children in college, by not having to purchase postage stamps, envelopes, money orders or write paper checks, make a trip to deliver the envelope to the post office or utilize expensive money transfer services including Western Union or American express's MoneyGram,
whereby the recipient of the funds from the electronic check of this invention, further saves time by not having to visit the office or location of it's FI to deposit the electronic funds transfer or electronic check,
Whereby consumers and businesses can receive the benefits of transmitting funds electronically without spending valuable resources to purchase expensive communications systems, even when the funds being transferred are small.

3) The method of claim 1 further including the receipt and payment of bills electronically comprising:
(a) requiring bill senders to obtain a pair of public-private electronic signature keys wherein said keys are based on the Public Key Infrastructure (PKI) specification and said key may be generated by various encryption algorithms including RSA public key encryption from RSA Security Inc,
(b) a means wherein said bill senders receive an electronic signing certificate created by an entity that is recognized by the bill sender and bill payer as performing the role of a certification authority by verifying the identity of said bill sender, certifying that said bill sender owns said public key, and specify the terms and conditions for how the certificate, public key and its associated private key are to be used,
(c) providing a means wherein said bill sender creates and electronically signs said bills using the bill senders private electronic signature key,
(d) providing a means wherein said bills are specially formatted thereby allowing software that implements the electronic funds transfer method of claim 1, to open and have access to the data elements in said bill,
(e) providing a means wherein said bill is transmitted electronically to said bill payer by a communication means including EMAIL, HTTP, FTP, or INSTANT MESSAGING (IM)
(i) providing a means wherein the bill payer, using software that implements the electronic funds transfer method of claim 1, opens said electronic bill and rejects the bill if any of the following conditions exist, the bill data is incorrect or the bill's electronic signature is invalid,
(j) providing a means wherein the bill payer creates and transmits to the bill sender an electronic funds transfer transaction to be used as payment for said bill,
Whereby, bill senders leverage the bill payers existing electronic communications means to transmit bills to and receive payment electronically from said bill payers using the electronic funds transfer process of this invention, thereby reducing the turnaround time and expense involved in sending and processing bills, over the conventional paper and postal process,
Whereby bill payers receiving the electronic bill of this invention and making payments electronically, have an advantage over bill payers that receive electronic bills as text email and are still required to print the text email bills and make payments using existing conventional methods.

4) The electronic bill receipt and electronic funds transfer system of claim 3 further including extracting payment information from the electronic bill and populating the electronic funds transfer transaction that will be used to pay the bill, with payment data extracted from the bill thereby reducing the amount of data the bill payer enters to complete the electronic funds transfer transaction,
Whereby the bill payer benefits by spending less time entering the data required in completing the electronic funds transfer transaction, thereby making the bill paying experience more convenient.

5) The electronic bill receipt and payment system of claim 3 further including creating an integrated software environment to receive and pay electronic bills using the electronic funds transfer method of this invention comprising:
(a) providing software that combines the electronic communications by the bill payer with the electronic funds transfer and bill payment methods of this invention thereby removing the need for the bill payer to install or use separate software to receive and pay bills electronically,
Whereby entities including Internet Service Providers (ISP), phone companies, that provide the software used by said bill payer to communicate electronically, provide an added benefit to the bill payer by integrating or embedding the bill payment method of this invention into the communication software used by the bill payer thereby providing a convenient bill payment software environment.

6) The integrated electronic communication and bill receipt and payment software environment of claim 5 further including a means wherein bill payers notify bill senders that they wish to receive and pay their bills electronically by means of this invention
Whereby entities including Internet Service Providers (ISP), phone companies, that provide the software used by the bill payer to communicate electronically, provide an added benefit to the bill payer by integrating or embedding the bill payment method of this invention into the communication software thereby providing a convenient software environment where the bill payer can receive and pay bills.

7) The integrated electronic communication and bill receipt and payment software environment of claim 5 further including a means wherein the communications service provider provides another unique electronic communications address to the bill payer, that is supplied to bill senders, thereby allowing the service provider to restrict communications using this electronic address to bills or bill related communication by filtering out communications that do not have a bill's electronic signature, whereby the bill payer's fear of receiving unsolicited communications if the bill payer's regular electronic communication address is disclosed to the bill sender is alleviated.

8) The integrated electronic communication and bill receipt and payment software environment of claim 5 further including a means wherein electronic communications service providers using the electronic signature accompanying bills as a means of identifying the sender and as a means to filter out unwanted communication.

9) The electronic check funds transfer method of claim 2 further including creating an integrated software environment to create, send and received electronic funds comprising:
(a) providing software that combines the electronic communications of the electronic check creator with the functionality of creating and receiving electronic checks of this invention thereby removing the need for the bill payer to install or use separate software to create, send or receive checks electronically,
Whereby entities including Internet Service Providers (ISP), phone companies, that provide the software used by the check creator or the check recipient, to communicate electronically, provide an added benefit to the user by integrating or embedding the electronic check funds transfer method of this invention into the communication software used by the check sender or recipient thereby providing a convenient funds transfer software environment.

10) The electronic bill receipt and electronic funds transfer system of claim 3 further including encrypting the electronic bill using information known to both the bill sender and receiver as the encryption key, thereby requiring the recipient to supply the encryption key used to encrypt the bill before gaining access to it, whereby anyone who may gain unauthorized access the recipient's electronic communication system is prevented from accessing the bill if they do not have the decryption key.

11) The electronic funds transfer method of claim 1 further including encrypting the electronic funds transfer using information known to both the sender and receiver as the encryption key, thereby requiring the recipient to supply the encryption key used to encrypt the funds transfer before gaining access to it, whereby anyone who may gain unauthorized access the recipient's electronic communication system is prevented from accessing the electronic funds transfer if they do not have the decryption key.
